(19) United States
(12) Patent Application Publication
(10) Pub. No.: US 2004/0153524 A1
(43) Pub. Date: Aug. 5, 2004

(54) Multiprocessor system and method for operating a multiprocessor system

(76) Inventors: I-Chih J. Kang, Eindhoven (NL); Om Prakash Gangwal, Eindhoven (NL); Andre Krijn Nieuwland, Eindhoven (NL)

Correspondence Address: Philips Electronics North America Corporation, Intellectual Property & Standards, 1109 McKay Drive, M S41 SJ, San Jose, CA, 95131, US

(21) Appl. No.: 10/481,875

(22) PCT Filed: Jun. 20, 2002
(86) PCT No.: PCT/IB02/02337

(30) Foreign Application Priority Data
Jun. 29, 2001 (EP) 01202517.7

(51) Int. Cl. G06F 15/167

(52) U.S. Cl. 709/213

(57) ABSTRACT

A multiprocessor system according to the invention comprises at least a dedicated processor (1.6) and a further processor (1.3), and a memory (1.5) shared by the processors. The shared memory (1.5) and processors (1.6., 1.3) are coupled to an interconnection network (1.7). The processors are arranged for transferring data to each other via a buffer (2.1) in accordance with a synchronization protocol. The dedicated processor (1.3) comprises facilities for administrating information relating to the synchronization protocol and a copy of at least part of this information is maintained in the shared memory (2.1).

The invention relates to a multiprocessor system.

The invention further relates to a method for operating a multiprocessor system.

Signal-processing functions determine the performance requirements for many products based on standards like MPEG-x, DVB, DAB, and UMTS. This calls for efficient implementations of the signal processing components of these products. However, because of evolving standards and changing market requirements, the implementation requires flexibility and scalability as well. A macropipeline setup is a natural way to model these applications, since streams of data are processed; in this setup the functions (tasks) are the stages and there are buffers between the stages to form the pipeline. This is a way to exploit task-level parallelism (TLP), because all stages can operate in parallel.

A multiprocessor system comprising a plurality of processors is very suitable for implementation of such a macropipeline. A multiprocessor system may comprise several types of processors, such as programmable processors, e.g. RISC-processors or VLIW processors, or dedicated hardware. One processor may execute a particular task, or more than one task in a time-shared fashion. As the complexity of the signal processing functions and their implementation in a multiprocessor system becomes more and more complex, it becomes increasingly more difficult to test and debug such a system.

It is a purpose of the invention to provide a multiprocessor system which can relatively easily be debugged and a method of operating the multiprocessor system which facilitates debugging.

A multiprocessor according to the invention in accordance with this purpose is claimed in claim 1. A method according to the invention in accordance with this purpose is claimed in claim 8.

In a macropipeline implemented on a multiprocessor system data has to be exchanged between the processors, e.g. via a buffer. A synchronization protocol is necessary to synchronize data generation of a first processor with data consumption of a second processor succeeding the first one in the pipeline. Such a synchronization protocol uses synchronization information, e.g. a pair of semaphores. For example, a first semaphore indicates the number of buffer elements available to the first processor for writing new data, and a second semaphore indicates the number of buffer elements available to the second processor to be read.

In an implementation which comprises a dedicated processor, the administrating information is preferably stored where it is most essential. For example if the dedicated processor is arranged for writing data to the buffer the first semaphore should be quickly accessible to that processor e.g. in the form of a dedicated register. However, when debugging the system is necessary, or the system has to be tested, e.g. to find bottlenecks in the pipeline it is very difficult to trace this scattered information. According to the invention therefore a copy of at least part of this administrating information is maintained in the shared memory. In this way analysis of the operation of the system is strongly simplified as more relevant information is available in a clustered fashion. And since this information resides in memory, it is accessible by a software debugger.

It is noted that U.S. Pat. No. 6,173,307 B1discloses a multiprocessor system comprising circular queue shared by multiple producers and multiple consumers. Any producer or consumer can be permitted to preempt any producer or consumer at any time without interfering with the correctness of the queue.

It is further noted that U.S. Pat. No. 4,916,658 describes an apparatus comprising a dynamically controlled buffer. The buffer is suitable for storing data words consisting of several storage locations together with circuitry providing a first indicator that designates the next storage location to be stored into, a second indicator designating the next storage location to be retrieved from, and circuitry that provides the number of locations available for storage and the number of locations available for retrieval.

In a multiprocessor system the processors may carry out more than one task, because the number of tasks can be greater than the number of processors. Also the multiprocessor system may be dynamically reconfigured, e.g. to adapt to a changing bitrate of a data stream processed by the system. In such cases an embodiment of the multiprocessor system according to the invention as claimed in claim 2 is advantageous. When dynamically reconfiguring the system, changing a certain task's communication partner from a hardware task (using distributed info, for example stored in a shell) to a software task (using centralized info in shared memory) can be done much more smoothly because both formats already coexist. For multi-tasking hardware devices, each task has its private copy of the administration information of the buffers it uses stored in the shell (in registers). This increases the size of the shells. This can be avoided by sharing the registers among the tasks. However, each time a task is swapped out, the current state of its buffers must be explicitly saved to memory and each time it is scheduled again, all the state must be restored again. This has a negative impact on the run-time performance. By keeping a centralized copy of the buffer administrative information in memory at all time, saving the buffer state upon task switches is not required because it is already there and up to date.

Claim 3 describes a first implementation of the synchronization protocol. In this embodiment each of the processors maintains a respective synchronization counter. A producing processor (i.e. writing tokens) maintains a first synchronization counter Np and a consuming processor (reading this information) maintains a second synchronization counter Nc. Provided that the buffer used for exchanging information has a size Nb, the number N1 of tokens available to the first processor is

N1=Nc−Np mod Nb, (1)

and the number of tokens N2 available to the second processor is

N2=Np−Nc mod Nb. (2)

Each time that the producing processor has written a token and releases this to the consuming processor it updates the first synchronization counter Np and each time when the consuming processor has read a token and releases it to the producing processor it updates the second synchronization counter Nc.

At any time a processor can check the number of tokens which it can use by issuing a first command (claim). This results in a verification whether an amount of buffer space is available to it by comparing both synchronization counters. The first processor uses equation 1 and the second processor uses equation 2 for verification.

The second command (release) results in an increment of the synchronization counter assigned to the processor with the number of released tokens.

The first and the second command may be implemented in the form of a function call in software or by means of dedicated signal in hardware.

A particular embodiment is described in claim 4. In this embodiment the at least one processor can reserve a zone within the buffer which it can arbitrarily use, e.g. for random access or for temporary storage of data.

Instead of maintaining the number of released tokens as in the embodiment of claim 3 it is alternatively possible to maintain the number of available tokens in a counter. In this case the counter for the number of tokens available for writing will be incremented by the consuming processor, and will be decremented by the producing processor. The counter for the number of tokens available for reading will be incremented by the producing processor, and will be decremented by the consuming processor. This embodiment is described in claim 5.

Although the copy in shared memory could be maintained by arbitrary means, it is preferred that the dedicated processor also updates the copy in shared memory. The dedicated processor ‘knows’ at which moment the changes in the administration information occur.

The buffer is preferably located in shared memory e.g. using the same memory used for the copy of the administrating information.

A shell coupled to a processor facilitates multitasking, in that it may reduce the number of interrupts which has to be handled by the processor itself. This reduces the number of times that an idle processor has to be activated unecessarily, or that a processor has to interrupt an other task which it is processing. In this way the efficiency of the processor is improved.

Several options are possible to implement such a shell for selecting interrupt signals depending on the type of interrupt signals and how they are encoded. In an embodiment the interrupt signals are indicative for a data channel of the processor. A practical way to iplement this is by assigning bits in a register to respective input channels of the processor. For example a 32 bit register could support 32 input channels, wherein for example channel 0 is assigned bit 0, channe 1 is assigned bit 1 of the register etc. When an other processor sents an interrupt signal destinated for channel k of the processor the corresponding bit k of the signal register is set. The shell of the receiving processor can select specific interrupt signals by means of a mask register, wherein each bit represents for a particular channel whether the processor wants to ignore the interrupt or not. E.g. if the bit corresponding to channel two is masked, this signal will not cause an interrupt in the processor, and no wake up will happen. In this example, the processor could be busy with processing, in which all bits will be masked, or the processor/task could be waiting for a full/empty token on channel 1, in which case it is not interested on what happens on channel 2.

The signal and the mask register could have an arbitary number of bits depending on the number of channel which should be supported. Alternatively it is possible to support each channel by a number and use a list or look-up table to determine whether the processor should be interrupted for that channel or not. This is however a more complex solution.

Instead of identifying a interrupt signal by its channel number it could be identified by a task number instead. In this embodiment all channels with signals for a specific task set the same bit in the signal register of the shell. In this way, a number of tasks equal to the number of bits in the signal register could be uniquely addressed, whereas each task may have more than one channel. The waiting is a little less specific than with unique channel identification, but the number of unnneccessary wake-ups is still small and more channels can be supported with limited hardware.

Of course, the taks numbers do not have to be identical to the bit numbers, (it is just simple to do it that way) as long as the relation is defined. Furthermore, it also possible that (groups of) tasks share the same signal-interrupt-number.

Instead of identifying the task carried out by the receiver, the senders task identification number could be signalled. In that case the receiving processor can select interrupt signals from a specific task instead of for a specific task. It may depend of the number of external tasks and the number of tasks on the processor personal preference or what seems the most usefull/efficient.

These and other aspects of the invention are described in the drawing. Therein

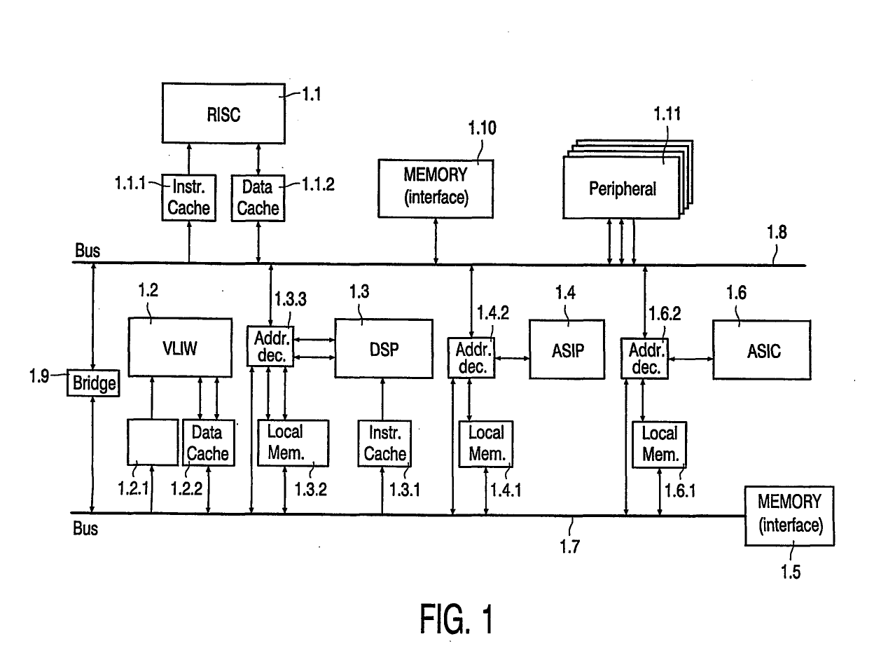

FIG. 1 schematically shows a data processing apparatus

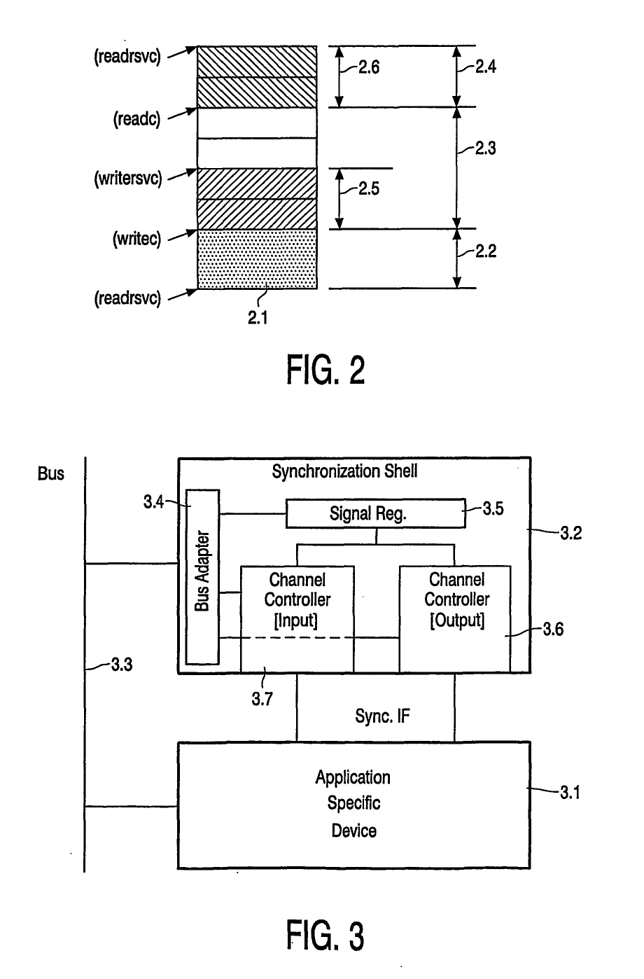

FIG. 2 schematically shows a way in which synchronization counters indicate partitions of a buffer,

FIG. 3 illustrates a synchronization shell for a processor, and

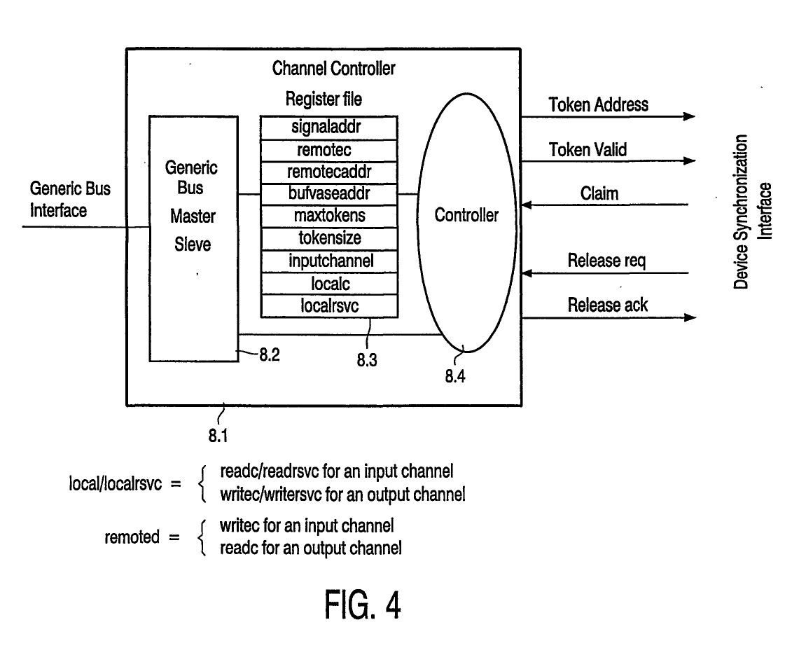

FIG. 4 illustrates a channel controller.

FIG. 1 shows a data processing apparatus comprising at least a first 1.6 and a second processing means 1.3. The first processing means, an application specific processor 1.6 is capable of providing data by making tokens available in a buffer means, located in memory 1.5. The tokens are readable by the second processing means 1.3, a digital signal processor, for further processing. The data processing apparatus further comprises a RISC processor 1.1, a VLIW processor 1.2, and an ASIP 1.4. The VLIW processor 1.2, the DSP 1.3, the ASIP 1.4, the memory 1.5 and the ASIC 1.6 are mutually coupled via a first bus 1.7. The RISC processor 1.1 is coupled to a second bus 1.8 which is coupled on its turn to the first bus 1.7 via a bridge 1.9. A further memory 1.10 and peripherals 1.11 are connected to the second bus 1.8. The processors may have auxiliary units. For example the RISC-processor 1.1 comprises an instruction cache 1.1.1 and data cache 1.1.2. Likewise the VLIW processor has an instruction cache 1.2.1 and data cache 1.2.2. The DSP 1.3 comprises an instruction cache 1.3.1, a local memory 1.3.2, and an address decoder 1.3.3. The ASIP 1.4 comprises a local memory 1.4.1 and address decoder 1.4.2. The ASIC 1.6 comprises a local memory 1.6.1 and address decoder 1.6.2. The processing means 1.6, 1.3 are each assigned a respective synchronization indicator. Both synchronization indicators are accessible by both the first 1.6 and the second processing means 1.3. The first synchronization indicator is at least modifiable by the first processing means 1.6 and readable by the second processing means 1.3. The second synchronization indicator is at least modifiable by the second processing means 1.3, and readable by the first processing means 1.6.

Each of the synchronization indicators is represented by a counter. The counter which represents the first synchronization indicator (writec) is indicative for a number of tokens being written by the first processing means 1.6. The counter which represents the second synchronization indicator (readc) is indicative for a number of tokens being read by the second processing means 1.3.

Several options are possible for the skilled person to indicate the number of tokens by a counter as long as a comparison of the counter values makes it possible to calculate the number of tokens which are available to each of the processors. For example the counter value could be equal to the number of tokens mod n, wherein n is an integer value. Otherwise each step of the counter could represent a fixed number of tokens, or a token could be represented by a number of steps of the counter value.

In a practical embodiment the counters are a pointer to the address up to which the buffer means is made available to the other processor. This is schematically illustrated in FIG. 2. This Figure schematically shows a buffer space 2.1 within the memory 1.5 which is used by the first processing means 1.2 for providing data to the second processing means 1.3. The buffer space 2.1 is arranged as a cyclical buffer. The buffer space 2.1 comprises a first zone 2.2 and a second zone 2.4 which contains data written by the first processing means 1.2, which is now available to the second processing means 1.3. The buffer space 2.1 further comprises a third zone 2.3 which is available to the first processing means 1.2 to write new data. The producer-counter writec indicates the end of the first zone 2.2, and the consumer-counter readc points to the end of the second zone 2.3.

A portion 2.6 within the first zone 2.2 and the second zone 2.4 is reserved by the reservation counter readrsvc in combination with the synchronization counter readc. A portion 2.5 within the third zone 2.3 is reserved by the reservation counter writersvc in combination with the synchronization counter writec. As will be illustrated with reference to FIGS. 3 and 4 the synchronization information comprising the first synchronization counter writec, the second synchronization counter readc, and the reservation counters readrsvc and writersvc are stored in combination with other information in a channel controller of a synchronization shell coupled to the application specific device 1.6 (indicated in FIG. 3 as 3.1).

Referring to FIG. 3, the application specific device 3.1 is coupled to the bus 3.3 via a synchronization shell 3.2. In this way the application specific device 3.1 is responsible for the computational tasks, and the synchronization shell performs the communication tasks. For that purpose the synchronization shell 3.2 comprises a bus adapter 3.4, a signal register 3.5 for storing the identity of tasks for which the synchronization shell 3.2 has received a message. The synchronization shell 3.2 further comprises channel controllers 3.6, 3.7. These serve to convert commands of the processor 3.1 in signals to the bus 3.3. Usually an application specific device 3.1 will execute less tasks in parallel than is the case for a programmable processor 3.1.

FIG. 4 shows a channel controller 4.1 of the synchronization shell in more detail. The channel controller 4.1 comprises a generic bus master slave unit 4.2, a register file 4.3 and a control unit 4.4.

The bus adapter 3.4 and the generic bus master slave unit 4.2 together couple the channel controller 4.1 to the bus. The bus adapter 3.4 provides an adaptation from a particular interconnection network, e.g. a PI-bus or an AHB-bus to a generic interface. The generic bus master slave unit 4.2 provides for an adaptation of the synchronization signals to said generic interface. In this way it is possible to support different channel controller types and different buses with a relatively low number of different components.

The register file 4.3 stores the synchronization information.

In case the device synchronization interface of a processor 3.1 issues the signal Claim in order to claim a number of writable or readable tokens in the buffer, the control unit 4.4 verifies whether this number is available by comparing the locally stored value of the remote counter remotec with its reservation counter localrsvc. The notation remotec signifies writec for an input channel and readc for an output channel. The notation localrsvc refers to readrsvc for an input channel and writersvc for an output channel.

If the verification is affirmative, the address of a token Token Address is returned. Otherwise, the upper boundary address of the buffer space reserved for the processor 3.1 could be returned. The signal Token Valid indicates if the claim for tokens was acknowledged, and the processor's synchronization interface can rise the signal Claim again. In this way a token address can be provided to the processor at each cycle. If the outcome of the first verification is negative, the channel controller 4.1 reads the remote counter indicated by the address remotecaddr and replaces the locally stored value remotec by the value stored at that address. The control unit 4.4 now again verifies whether the claimed number of tokens is available.

If the request fails, the channel controller 4.1 could either poll the remote counter regularly in a polling mode or wait for an interrupt by the processor with which it communicates in an interrupt mode. In the mean time it may proceed with another task. The register file in the channel controller comprises the pointer sgnl_reg_addr indicating the signal register address of the other device with which the processor is communicating. An interrupting processor may leave in the signal register of a device an indication of the task or of the channel for which the interrupt took place.

The variable inputchannel in the register indicates to the channel controller whether the present channel is an input or an output channel and which of these modes is selected for this channel. The variables maxtoken and tokensize respectively indicate the total number of tokens available in the buffer and the size of the tokens in bytes.

After a successful claim the variable localrsvc is updated in conformance with the number of tokens that was claimed.

Instead of the variable remotec, the register file could comprise a variable indicating the number of available tokens calculated with the last verification.

In case that the processor 3.1 signals Release_req the local counter localc is updated in accordance with this request. This local counter localc is readc for an input channel and writec for an output channel. Optionally the signal Release_req may be kept high so that the processor 3.1 is allowed to release tokens at any time. However, this signal could be used to prevent flooding the controller when it is hardly able to access the bus.

Alternatively the synchronization process could be implemented in software by using a claim and a release function. By executing the claim function a processor claims a number of tokens for a particular channel and waits until the function returns with the token address. By executing the release fuiction the processor releases a number of tokens for a particular channel. Separate functions could exist for claiming tokens for writing or tokens for reading. Likewise separate functions may be used for releasing.

According to the invention a copy of at least part of the synchronization information is maintained in the shared memory.

The information maintained as a copy may comprise any information which is useful to trace the operation of the dedicated processor, for example a value of the synchronization counter which is maintained by that processor.

By way of example the copy in shared memory could be arranged according to the following datastructure as specified in the C-language:

| | |
|---|---|
| { | |
| int id; | //channel identifier |
| int maxtokens; | //maximum number of tokens in channel |
| int flags; | //mode flags (e.g. interrupt/polling) |
| CHP_taskT* producer; | //producer task pointer |
| CHP_taskT* consumer; | //consumer task pointer |
| int tokensize; | //size of tokens |
| char* bufbaseaddr; | //base address of the buffer in memory |
| unsigned writec; | //write counter |
| unsigned readc; | //read counter |
| unsigned writersvc; | //write reserve counter |
| unsigned readrsvc; | //read reserve counter |

CHP_channel_hwT* pchanregs;
CHP_channel_hwT* cchanregs;
} CHP_channelT;

Apart from the synchronization counter values writec and readc and the reservation counter values writersvc and readrsvc this data structure comprises the following data.

id is a value identifying the channel, so as to enable a processing scheme including a plurality of channels, for example a first channel for transferring data from a first processing means to a second processing means, a second channel for transferring data from the second processing means to the first processing means and a third channel for transferring data from the second processing means to a third processing means.

The value maxtokens indicates the size of the buffer, i.e. as the number of tokens which can be stored in the buffer.

The value flags indicates properties of the channel, e.g. if the synchronization is polling or interrupt based, and whether the channel buffers are allocated directly or indirectly. As an alternative it can be decided to give the channel predetermined properties, e.g. restrict the implementation to interrupt based synchronization with directly allocated buffers. In that case the value flags may be omitted.

producer and consumer are pointers to the structure describing the task of the first processing means, the producer, and the task of the second processing means, the consumer.

The task structure may contain for example

an identifier for the task (whose task structure is it)

a function pointer (if it is a task on the embedded processor; then after booting the root_task can jump to this function and start the application. Void otherwise.

a device type: to indicate on what type of device the task should be running.

This is useful for the boot process: a task running on a DSP or on an Embedded processor has to be initialized in a different way than a task running on dedicated hardware. By having a major device type, it is easy to select the proper boot procedure.

a device number: This enable to distinguish between e.g. the first hardware co-processor from the second. this can be done by giving them a unique number.

the number of channels

a list of pointers to channel datastructures.

In this way, when e.g. a UNIX task is started, it can first read its task structure, and then read all the information about all the channels connected to that task. This makes the booting process a lot easier, and avoids that very time some task is added, a control process has to be modified to have all tasks load the proper data structures. The integer token_size indicates the size of the tokens which is exchanged via the channel.

The pointer bufbaseaddr refers to the base address of the buffer in memory

The pointers CHP_channel_hwT* pchanregs and CHP_channel_hwT* cchanregs facilitate access to the registers of a channel controller by software. These are simply pointers to the physical locations of the hardware registers. If any of the fields is 0, then this means that the corresponding task is a software task.

For completeness, we also discuss the case when two hardware tasks are communicating. In this case, signaladdr of the producer is set to the address of the signal register in the consumer's synchronization shell, and remotecaddr is set to the address of the localc register of the consumer channel controller. Another option is to set remotecaddr to the readc field in the channel record in shared memory, however this has the disadvantage that the value of the remote counter read may be slightly outdated since the consumer's shell updates the memory a little later after it updates its local register. The setting of the registers for the consumer is just the other way around.

Dynamic reconfiguration entails changing the topology of the task graph representing a certain application. This means for instance that tasks may be stopped and removed, and that certain channels may be reconnected to other tasks. The most interesting scenario in this context is when a certain channel is reconnected on one side (producer or consumer) to another task, and it is of a different implementation. For instance, a producer task (hardware) was connected to a hardware consumer task, and after reconfiguration it has to communicate with a software task. In this case, the software task can use the channel immediately because the channel record is already present and up to date. For the hardware task, several fields in its channel administrative registers have to be changed, namely signaladdr is set to the signal controller address of the CPU the new software task is running on.

remotecaddr is set to the address of the readc field in the channel record. Note that this step is not needed if previously it was already the case even though two hardware tasks were communicating.

To avoid the hardware task from using these registers while they are being updated, it is suspended first and resumed after the updates have been done.

Switching a task's communication partner from a hardware task to another hardware task is also easily done with a channel record in memory. The new task's channel controller registers are simply uploaded from shared memory before being started.

Multiple tasks may be mapped on one single hardware device, e.g. DCT and IDCT. Both tasks may have different input and output channels and therefore need separate channel controllers and registers. Or, we can use the same set of registers in the device shell to implement the channels for both tasks, thereby reducing the silicon area. Without a copy of the administrative information in memory, this requires that when a task is scheduled out, the administrative information of its channels must be explicitly saved in memory, and once it is scheduled again, the administrative information of the corresponding channels can be restored from memory into the registers.

With the proposed approach, a “shadow state” of the channel registers is always present in memory, therefore the task switches on the hardware device are speeded up because no state saving of the channel administrative information is required. Furthermore, the task that is communicating with the task that is scheduled out never notices this task switch because it can still work on the shared memory channel record.

It is remarked that the scope of protection of the invention is not restricted to the embodiments described herein. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general purpose processor. The invention resides in each new feature or combination of features.

1. Multiprocessor system comprising at least a dedicated processor and a further processor, and a memory shared by the processors, which shared memory and processors are coupled to an interconnection network,
the processors being arranged for transferring data to each other via a buffer in accordance with a synchronization protocol, wherein the dedicated processor comprises facilities for administrating information relating to the synchronization protocol, and wherein a copy of at least part of this information is maintained in the shared memory.

2. Multiprocessor system according to claim 1, wherein said information comprises at least the following information elements
an address indicating the location of the buffer,
an indication for the size of the buffer,
a synchronization counter relating to the progress of the data transfer, and wherein of each of this information elements a copy is maintained in the shared memory.

3. Multiprocessor system according to claim 2, wherein the synchronization counter is maintained by the further processor and is readable by the dedicated processor, wherein the dedicated processor maintains a further synchronization counter which is readable by the further processor, wherein the synchronization protocol comprises
a first command which when issued by a processor results in a verification whether an amount of buffer space is available to it by comparing both synchronization counters,
a second command which when issued by a processor results in a release of a part of its buffer space by updating the synchronization counter which it maintains.

4. Multiprocessor system according to claim 3, wherein at least one of the processors locally maintains a reservation counter, wherein
the first command issued by a processor results in a verification whether an amount of buffer space is available to it by comparing its reservation counter with the synchronization counter maintained by the other processor, the reservation counter being updated if the outcome of the verification is affirmative.

5. Multiprocessor system according to claim 2, comprising a further counter, both counters being maintained by and readable by both processors, one of the counters being indicative for an amount of buffer space available for said dedicated processor, and the further counter being indicative for said further processor.

6. Multiprocessor system according to claim 1, characterized in that the dedicated processor also updates the copy in shared memory.

7. Multiprocessor system according to claim 1, wherein the buffer is located in shared memory.

8. Method for operating a multiprocessor system comprising at least a dedicated processor and a further processor, and a memory shared by the processors, which shared memory and processors are coupled to an interconnection network, according to which method the processors are arranged for transferring data to each other via a buffer in accordance with a synchronization protocol, wherein the dedicated processor comprises administrates information relating to the synchronization protocol, and maintains a copy of at least part of this information in the shared memory.
